(19) United States
(12) Patent Application Publication
(10) Pub. No.: US 2013/0045471 A1
(43) Pub. Date: Feb. 21, 2013

(54) TRAINING SYSTEM FOR INVESTIGATIONS OF BIOENGINEERED PROTEINS

(71) Applicants: Michele Gilbert, Albany, CA (US); Ingrid Miller, Dixon, CA (US); Laurie Usinger, Lafayette, CA (US)

(72) Inventors: Michele Gilbert, Albany, CA (US); Ingrid Miller, Dixon, CA (US); Laurie Usinger, Lafayette, CA (US)

(73) Assignee: BIO-RAD LABORATORIES, INC., Hercules, CA (US)

(21) Appl. No.: 13/371,128

(22) Filed: Feb. 10, 2012

Related U.S. Application Data
(60) Provisional application No. 61/446,828, filed on Feb. 25, 2011.

(51) Int. Cl. G09B 23/24

(52) U.S. Cl. 434/298

(57) ABSTRACT

Education and training in the procedures and materials for cell growth and protein expression are provided by an integrated system of modules, each fully equipped with reagents, for the entire span of procedures beginning with cell plating and inoculation and extending through protein expression, growth, purification, and assay, plus an instruction manual that sets forth all of the procedures, and in certain cases an assessment module. The system is supplied with bacterial cells already transformed for expression of proteins that are selected for their known expression procedures and properties, and is adaptable to any known protein.

### CROSS-REFERENCE TO RELATED APPLICATIONS

This application claims the benefit of U.S. Provisional Patent Application No. 61/446,828, filed Feb. 25, 2011, the contents of which are incorporated herein by reference.

### BACKGROUND OF THE INVENTION

1. Field of the Invention

This invention lies in the field of laboratory procedures for protein expression and purification.

2. Description of the Prior Art

Biological processes, cellular function and growth, and protein expression, including the expression and use of recombinant or bioengineered proteins, are procedures that are practiced extensively in biotechnology laboratories and in academia. Nevertheless, individuals entering industry or gaining employment in biotechnology laboratories often arrive at their new jobs with little or no hands-on experience, and consequently lack the “best practice” skills and practical equipment training that they need to be fully productive at their work. There is therefore a need for a training and educational system that allows the inexperienced practitioner to learn and practice standard laboratory procedures by performing them on biological materials whose response to and behavior under these procedures is well established.

### SUMMARY OF THE INVENTION

The present invention provides a system and method for education and training in the core processes of protein expression, purification, and assay. The system of the invention can be formulated as a series of modules that collectively represent the various stages in the expression, purification, and assay of a known protein, each stage containing a full set of reagents, media, and other disposable components, as well as an instruction manual with directions for performing standard procedures for each stage, and in certain embodiments, an assessment module for evaluating the users' understanding of the processes taught. Certain stages are represented by two or more alternative modules, offering the instructor and the trainee a choice among different means of performing those stages. Certain stages can also be sold or purchased independently of the system as a whole, for purposes of replenishing a supply for a particular stage, offering the instructor or trainee a choice at the point of use, or adapting the system to smaller or larger numbers of trainees. Each of these variations is made possible by the modular nature of the system, wherein the various modules are separable and recombinable, replaceable, and reusable.

### DETAILED DESCRIPTION OF THE INVENTION AND SELECTED EMBODIMENTS

In a typical system, the modules will include:
(A) a cell growth and protein expression module;
(B) an electrophoresis module;
(C) a purification module; and
(D) an assay module.

Illustrative components of each module are as follows.

Cell Growth and Protein Expression Module. This module can include, for example, Petri dishes, a set of inoculation loops, a set of 50 mL sterile tubes, and a growth and expression reagent pack. The growth and expression reagent pack can include lyophilized ampicillin, LB (lysogeny broth) broth, LB agar powder, lysozyme, isopropyl-β-D-thio-galactoside (IPTG), E. coli BL21(DE3) bacterial cells transformed with a plasmid to express the protein selected for training purposes, 10× phosphate buffered saline, sterile water, 20% sterile glucose, and imidazole stock solution. The BL21(DE3) bacterial cells can be replaced with any other bacteria whose expression and growth conditions are known and that has been transformed with an appropriate plasmid. The plasmid in each case will be one that encodes a protein of choice and has a tag that enables the protein to be purified easily. As noted below, the protein can be an enzyme or a fusion protein in which a peptide or protein is fused with an enzyme, so that the assay procedure to be performed with the assay module is an enzymatic assay, although other confirmatory assays such as Western blotting and ELISA can also be run. Fusion proteins can also facilitate the expression of the protein or increase its solubility or its molecular weight, or two or more of these effects. An example of an enzyme that can be used is dihydrofolate reductase (DHFR); an example of a fusion protein is a protein fused with glutathione s-transferase. Other enzymes and fusion proteins will be readily apparent to those skilled in the art. In general, any other protein that can be expressed and grown with the materials indicated above can be used. The plasmid will in many cases include a tag that will facilitate the purification of the protein in the purification module. Polyhistidine tags (His-tag) and metal affinity tags are examples. Others will be readily apparent to those skilled in the art.

An example of a list of components for the Cell Growth and Protein Expression Module is as follows: micro test tubes (2 mL), Petri dishes, sterile inoculation loops, sterile conical tubes, screwcap microcentrifuge tubes (1.5 mL), lyophilized ampicillin, LB nutrient agar powder, LB broth capsules, lyophilized lysozyme, E. coli strain BL21 (DE3) containing pDHFR, IPTG (1M), 10× PBS, imidazole stock solution, 20% sterile glucose, sterile water, and an instruction manual.

Electrophoresis Module. The electrophoresis module will be used to separate the expressed proteins in the cell growth and protein expression module from other proteins and cellular materials in the cell lysate. A particularly useful electrophoresis module is one formulated for SDS-PAGE (sodium dodecyl sulfate polyacrylamide gel electrophoresis). The module can include a running buffer such as Tris/Glycine/SDS buffer, a sample buffer such as Laemmli sample buffer, a stain such as Coomassie blue protein stain, and a set of protein standards spanning a range of molecular weight (for example, a mixture of six to twelve blue-stained recombinant protein standards).

An example of a list of components for the Electrophoresis Module is as follows: 10× Tris/Glycine/SDS buffer, Laemmli sample buffer, Bio-Safe Coomassie Stain, and Precision Plus protein dual color standards.

Purification Module. This module can assume any of several forms, examples of which are a pre-packed chromatography column module, a hand-packed purification module which contains materials for hand-packing a chromatography column, and a centrifugation purification module which contains materials for purification of the protein by centrifugation. Additionally, this module can include a set of desalting columns or materials to prepare desalting columns for further purification and buffer transfer.

Pre-Packed Chromatography Column Module. A module that utilizes a pre-packed column can include a cartridge such as the BIO-SCALE™ Mini PROFINITY™ IMAC (immobilized metal affinity chromatography) Cartridge, and spin columns prepacked with gel and an appropriate buffer, such as Micro Bio-Spin® (Bio-Rad Laboratories, Inc., Hercules, Calif.) 6 columns packed with gel and Tris buffer.

Hand-Packed Purification Module. A module designed for hand-packing a column can include a resin such as a nickel-charged affinity chromatography resin, a column such as a glass Econo Column (1.0 cm×5 cm), and spin columns such as the Micro Bio-Spin 6 columns. An example of a list of components for a hand-packed purification module is Profinity IMAC Ni-charged resin (10 mL), glass Econo columns (1.0 cm×5 cm), and Micro Bio-Spin 6 (Tris) columns.

Centrifugation Purification Module. A module designed for purification by centrifugation can include a nickel-charged affinity chromatography resin, a set of spin columns, a set of desalting columns, and a set of microcentrifuge collection tubes. An example of a nickel-charged affinity chromatography resin is Profinity IMAC Ni-charged resin (1.5 mL); examples of spin columns are Micro Bio-Spin empty columns; and examples of desalting columns are Micro Bio-Spin 6 (Tris) columns. Such modules can also include screwcap microcentrifuge tubes (1.5 mL), and collection tubes.

Assay Module. The assay module can utilize any protein assay protocol and will include a complete set of reagents and materials for performing the assay. Enzymatic assays are a prime example and are particularly convenient when the protein that is grown, expressed, recovered, and purified in the modules described above is an enzyme. One example of an enzyme that can be used is dihydrofolate reductase (DHFR); others will be readily apparent to those skilled in the art. The module will include a substrate for the enzyme and a cofactor when needed for the enzyme to function. For DHFR, a suitable substrate is dihydrofolic acid, with nicotine adenine dinucleotide phosphate (NADPH) as a cofactor. An example of a list of components for an enzymatic assay module is thus one containing DHF and NADPH.

Utilization of the system of the present invention will require certain common laboratory reagents and pieces of laboratory equipment that are commonly used in biotechnology laboratories. Such reagents and equipment include, for example, distilled deionized water, SDS-PAGE gels, and gel-staining trays, as well as plastics and consumables such as pipet tips,

Parafilm sealing film, transparent cuvettes, syringes, and fraction collection tubes. Common laboratory glassware, temperature control equipment, and other miscellaneous equipment will be readily apparent to those of skill in the art.

Instruction Manual. The system can also include an instruction manual containing the entire procedure, including all steps to be followed for each module and procedures for using each piece of equipment and each reagent in each module, as well as the results to be expected from each procedure when the procedures are performed correctly. The procedures will be standard procedures that are commonly used in biochemical laboratories, and will be well known to skilled biochemists and biologists. Instructions can thus be included for resuspending the lyophilized cells that are included in the cell growth and protein expression module, plating the cells on selective media, culturing the cells, monitoring the cell growth, inducing the protein expression by adding IPTG, harvesting the protein from the cells with a centrifuge, checking the expression of the protein by the electrophoresis module, purifying the protein with the chromatography module, checking the purity by the electrophoresis module, and checking the activity or confirming the identity of the purified protein with the assay module.

Assessment Module. An assessment module containing materials for use by educators or trainers can also be included or otherwise made available. The assessment module might serve the purpose of aiding educators or trainers in evaluating a trainee's understanding of the purpose and use of the materials and procedures, and in identifying particular areas in which the trainee needs improvement or needs to pay greater attention to details such as timing, operating conditions, proper use of equipment, or other aspects of the procedures.

In the claims appended hereto, the term “a” or “an” is intended to mean “one or more.” The term “comprise” and variations thereof such as “comprises” and “comprising,” when preceding the recitation of a step or an element, are intended to mean that the addition of further steps or elements is optional and not excluded. All patents, patent applications, and other published reference materials cited in this specification are hereby incorporated herein by reference in their entirety. Any discrepancy between any reference material cited herein or any prior art in general and an explicit teaching of this specification is intended to be resolved in favor of the teaching in this specification. This includes any discrepancy between an art-understood definition of a word or phrase and a definition explicitly provided in this specification of the same word or phrase.

What is claimed is:

1. A modular system for training an individual in laboratory procedures and the use of laboratory equipment for protein expression and purification, said system comprising:
(a) a cell growth and protein expression module, comprising bacterial cells transformed to express a selected protein, growth media, reagents that promote cellular growth and protein expression, and receptacles for containing said growth media and reagents;
(b) an electrophoresis module, comprising a running buffer, a sample buffer, a protein stain, and a set of protein standards spanning a range of molecular weight;
(c) a purification module, comprising columns and a resin selected to isolate said selected protein;
(d) an assay module, comprising all reagents needed to perform an assay for protein activity of said selected protein; and
(e) an instruction manual, comprising instructions for use of each of said modules.

2. The modular system of claim 1 further comprising an assessment module, combining materials for evaluating a user's performance or skills in utilizing all other of said modules and said instruction manual.

3. The modular system of claim 1 wherein said selected protein is an enzyme, and said assay module comprises a substrate for said enzyme.

4. The modular system of claim 3 wherein said enzyme is His-tagged dihydrofolate reductase.

5. The modular system of claim 3 wherein said enzyme is linked to glutathione-s-transferase for expression purposes.

6. The modular system of claim 1 wherein said purification module comprises a prepacked chromatography column with a resin that separates said protein from other proteins under chromatographic conditions and desalting columns.

7. The modular system of claim 1 wherein said purification module comprises an affinity chromatography resin, a glass chromatography column, and desalting columns.

8. The modular system of claim 1 wherein said purification module comprises an affinity chromatography resin, spin columns, desalting columns, and microcentrifuge collection tubes.

9. The modular system of claim 1 comprising three purification modules, including a prepacked chromatography column module, a hand-packed purification module, and a centrifugation purification module.
